(19) United States
(12) Patent Application Publication
(10) Pub. No.: US 2007/0001541 A1
(43) Pub. Date: Jan. 4, 2007

(54) Gravitational wave propulsion

(76) Inventor: Robert M. L. Baker JR., Playa del Rey, CA (US)

Correspondence Address: CHRISTIE, PARKER & HALE, LLP, PO BOX 7068, PASADENA, CA, 91109-7068, US

(21) Appl. No.: 11/173,080

(22) Filed: Jun. 30, 2005

Related U.S. Application Data
(63) Continuation-in-part of application No. 10/738,142, filed on Dec. 16, 2003, now abandoned.
Application No. 10/738,142 is a continuation-in-part of application No. 09/752,975, filed on Dec. 27, 2000, now Pat. No. 6,784,591.
Application No. 09/752,975 is a continuation-in-part of application No. 09/616,683, filed on Jul. 14, 2000, now Pat. No. 6,417,597.
Application No. 09/616,683 is a continuation-in-part of application No. 09/443,527, filed on Nov. 19, 1999, now Pat. No. 6,160,336.

(51) Int. Cl. B64D 45/00; G21H 1/00

(52) U.S. Cl. 310/301; 244/1 R

(57) ABSTRACT

A gravitational wave generating device comprising an energizing means such as magnetrons, which act upon energizable elements such as film bulk acoustic resonators or FBARs. A computer that controls the magnetrons' phase. A gravitational wave generation device that exhibits directivity and forms a gravitational-wave beam. The utilization of a medium in which the gravitational wave speed is reduced in order to effect refraction of the gravitational wave and be a gravitational wave lens. A gravitational wave generator device that can be directed in order to propel an object by its momentum or by changing the gravitational field nearby the object to urge it in a preferred direction and be a propulsion means.

### REFERENCE TO RELATED APPLICATIONS

This application is a continuation-in-part of application Ser. No. 10/738,142 filed Dec. 6, 2003, which is a continuation-in-part of application Ser. No. 09/752,975 filed Dec. 27, 2000, now U.S. Pat. No. 6,784,591, which is a continuation-in-part of application Ser. No. 09/616,683, filed Jul. 14, 2000, now U.S. Pat. No. 6,417,597, which is a continuation-in-part of application Ser. No. 09/443,527, filed Nov. 19, 1999, now U.S. Pat. No. 6,160,336.

### BACKGROUND OF THE INVENTION

This invention relates to the generation of gravitational waves that can be directed and utilized for propulsion. More particularly the invention relates to the generation of gravitational waves (GWs) by the use of energizing forces such as electromagnetic or nuclear to impart a third or higher derivative or oscillatory motion to a mass consisting of a collection of sub-masses or mass-pairs of energizable elements such as target nuclei, Cooper electron pairs, nano-devices, laser targets, or piezoelectric-crystal resonators.

There exist several alternative means to generate gravitational waves having practical applications to propulsion. As taught in the '336 patent a ratcheting or jerking spindle-arm (FIG. 8B of that Patent) enabled by magnets under the control of Individual Independently Programmable Coil System or IIPCS, under computer control, could be utilized for propulsion. As taught in the '597 patent the energizable elements can be very small coils or coil sets encased in a computer chip, current-carrying conductors, or small electromechanical devices. The energizing and energizable elements in '597 can be piezoelectric resonators, semiconductor based, nano-machines, micro-electric mechanical systems (MEMS), solenoids, and linear motors. The mass acted upon by the coil elements can be a permanent magnet or magnets, or electromagnets. The '597 patent also teaches that the GWs themselves can be the source of some additional gravitational field and can be utilized for propulsion especially if the GWs are of high frequency. As taught in the '591 patent an energizing means acts upon energizable elements such as molecules, atoms, nuclei or nuclear particles in order to create nuclear reactions or collisions, the products of which can move in a single preferred direction with an attendant impulse (jerk or harmonic oscillation) of an ensemble of target nuclei or other energizable elements over a very brief time period. It is taught in '591 that the target nuclei or energizable elements acting in concert generate a gravitational wave to be utilized for spacecraft propulsion. A preferred embodiment in '591 involves the use of a pulsed particle beam moving at the local gravitational wave speed in a target mass, which is comprised of target nuclei, to trigger a nuclear reaction and build up a coherent gravitational wave as the particles of the beam move through the target mass and impact target nuclei over very short time spans. The '591 patent also teaches the use of superconductors as a propulsion means. As taught in U.S. patent application Ser. No. 10/738,142; filed Dec. 6, 2003, the existing 33.9 fs pulse-duration, table-top, ultra-intense lasers can be utilized as energizing elements and their reflective targets can be utilized as energizable elements to generate GWs for applications such as propulsion.

The general concept of the present invention is to simulate or emulate GWs generated by gravitational-force, extensive energizable celestial systems (orbiting binary stars, asymmetrical star explosions, merger of black holes, etc) by the use of compact electromagnetic- or nuclear-force energizable systems. The latter systems generate over 35 orders of magnitude more force intensity (nuclear or electromagnetic compared to gravitational) and over 12 orders of magnitude greater frequency (GHz, THz, PHz, and higher compared to 100 kHz or a small fraction of 1 Hz) than the celestial systems. Electromagnetic and nuclear force energizable systems produce significant and useful GWs according to the various embodiments of the present invention, even though the compact systems are orders of magnitude smaller than extra-terrestrial, celestial systems. In the various embodiments of the present invention large numbers of small energizable elements, collected together in compact groups, are energized in a sequence or in concert by energizing elements emulating the motion of a much larger and extended body having a larger radius of gyration in order to enhance the generation of GWs. The laboratory generation of GW was discussed, for example, by Pinto & Rotoli in General Relativity and Gravitational Physics, 1988, World Scientific, Singapore. They found (page 560) terrestrial laboratory GW generation to be “1 . . . at the limit of the state of the art . . . ” but they did not take into account the now available new technology and less expensive devices and did not discuss the jerk mechanism for generating GWs or computer control of that process. Utilizing a directed GW beam from a GW generator one can propel a vehicle by reaction against the momentum carried away by the GW as in a conventional rocket, that is a rearward moving GW beam urges the vehicle carrying the GW-beam generating device in a direction opposite the motion of the GW beam. Alternatively, the GW beam “ . . . is itself the source of some additional gravitational field.” (Landau, L. D. &. Lifshitz, E. M., The Classical Theory of Fields, Fourth Revised English Edition (Pergamon Press, p. 349, 1975). Thus the gravitational field change by one or more gravitational-wave generators can urge a vehicle in a prescribed direction as taught in '597.

Arrays of small, micro- and submicroscopic devices, termed energizing and energizable elements such as target nuclei ('591), Cooper electron pairs in superconductors ('591), laser targets (the '142 application), or piezoelectric-crystal resonators '597, are utilized to generate a train of coherent gravitational waves or a GW beam. As the waves progress along the axis of such devices they are reinforced by the energizable elements, under the control of a computer controlled logic system, in order to be utilized for applications such as propulsion. Starting with a non-rotating, but jerking pair of masses in a dumbbell configuration, linear devices, such as a stack of such dumbbells exhibiting a common axis, evolve. These devices emulate an orbiting pair of masses. But the changing centrifugal force vector of an orbiting mass pair, which is tangent to orbit and represents a jerk, is replaced by the electromagnetic or nuclear-reaction jerked energizable elements of a non-orbiting set of masses that do not involve large g loads.

### DESCRIPTION OF PRIOR ART

Robert M. L. Baker, Jr. in U.S. application Ser. No. 09/616,683, filed Jul. 14, 2000, entitled Gravitational Wave Generator, now U.S. Pat. No. 6,417,597, teaches that a third time derivative or jerk of a mass generates gravitational waves (GWs) or produces a quadrupole moment and that the GW energy radiates in a plane normal to the axis of the jerk or normal to the plane containing the tangentially jerked elements or if a harmonic oscillation, then also radiates in a plane normal to the axis of the oscillation as described in Albert Einstein and Nathan Rosen (1937), “On Gravitational Waves,” Journal of the Franklin Institute 223, 43-54. The force producing such a jerk or oscillation can be gravitational attraction, centrifugal, electromagnetic, nuclear, or, in fact, any force. The magnitude of the jerk or, more specifically, the magnitude of the third time derivative of the moment of inertia of the mass squared, determines the magnitude of the generated GW determined, for example by a quadrupole approximation. This latter quantity is approximately equal to the product of a very small coefficient and the square of a kernel or function consisting of twice the radius of gyration of the mass times the change in force divided by the time interval required to create the force change. Or, if there is a continuous train of impulsive force changes, then the kernel is twice the radius of gyration times the force change times the frequency of the pulse train. The force energizing mechanism can be a particle beam, a laser, a magnet, or a microwave beam. The magnitude of the GW power is approximately proportional to the square of the kernel according to the general theory of relativity as discussed in '597. The research of Joseph Weber Joseph Weber (1960), “Detection and generation of gravitational waves,” Physics Review, Volume 117, Number 1, pp. 306-313, of Robert L. Forward and L. R. Miller (1966), “Generation and detection of dynamic gravitational-gradient fields,” Hughes Research Laboratories Report dated August 5, pp. 512-518, of L. Halpren and B. Laurent (1964), “On the gravitational radiation of a microscopic system,” IL NUOVO CIMENTO, Volume XXXIIIR, Number 3, pp. 728-751, Heinz Dehnen (1981), “Generation of gravitational radiation in the laboratory,” Z. Naturforsch, Volume 36a, pp. 948-955, et al. commencing in the 1950s, examined the use of piezoelectric crystals of the laboratory generation of GWs. These four references are incorporated herein by reference. Due to the availability of inexpensive piezoelectric-resonator-energizable elements and magnetron-energizing elements, as discussed in Woods and Baker (R. Clive Woods and Robert M. L. Baker, Jr. (2005), “Gravitational Wave Generation and Detection Using Acoustic Resonators and Coupled Resonance Chambers,” in the proceedings of Space Technology and Applications International Forum (STAIF-2005), edited by M. S. El-Genk, American Institute of Physics Conference Proceedings, Melville, N.Y., Volume 746, 1298, incorporated herein by reference), a HFGW generator can be fabricated and operated.

With regard to the prior art of GW propulsion there are the following references: W. B. Bonnor and M. S. Piper (1997), “The gravitational wave rocket,” Class. Quantum Grav, Volume 14, pp. 2895-2904; Giorgio Fontana (2000), “Gravitational Radiation and its Application to Space Travel,” paper CP 504, Proceedings of the Space Technology and Applications International Forum—2000, edited by M. S. Genk, American Institute of Physics; Robert M. L. Baker, Jr. (2000), “Preliminary Tests of Fundamental Concepts Associated with Gravitational-Wave Spacecraft Propulsion,” American Institute of Aeronautics and Astronautics: Space 2000 Conference and Exposition, Paper Number 2000-5250, Sep. 20, Aug. 21, 2001, Revision; D. Goodwin (2001), “A proposed experimental assessment of a possible propellantless propulsion system,” AIAA 2001-3653, July 9; Jeffrey Cameron (2001), “An Asymmetric Gravitational Wave Propulsion System,” AIAA-2001-3913 paper; George D. Hathaway (2003), “Force beam and gravity modification experiments: an engineer's perspective,” paper HFGW-03-121, Gravitational-Wave Conference, The MITRE Corporation, May 6-9; Giorgio Fontana (2003), “Gravitational radiation applied to space travel,” paper HFGW-03-111, Gravitational-Wave Conference, The MITRE Corporation, May 6-9; Glen A. Robertson (2003), “Analysis of the impulse experiment using the electromagnetic analog of gravitational waves,” paper HFGW-03-116, Gravitational-Wave Conference, The MITRE Corporation, May 6-9; and Giorgio Fontana, (2005), “Gravitational Wave Propulsion,” Space Technology and Applications International Forum (STAIF-2005), edited by M. S. El-Genk, American Institute of Physics, Melville, N.Y., Volume 699, Paper F02-003; all of which are incorporated herein by reference. All of these technical publications suggested various means to achieve GW propulsion, some with the caveat that such propulsion was not now practical. On the other hand, none of them proposed a specific and realizable gravitational wave generator, which can be fabricated by a person reasonably skilled in the art, to achieve practical gravitational wave generation and, therefore, propulsion.

A preferred embodiment of the invention relies on the use of microwave generators, for example, magnetrons, such as those found in conventional microwave ovens, to energize piezoelectric crystals, found, for example, in Film Bulk Acoustic Resonators or FBARs utilized in cell phones, and thereby cause mechanical deformation or jerking in the crystal-lattice molecules or the vibrating membrane attached to the piezoelectric material of the FBAR and generate GWs. FBARs are a sophisticated development not only of piezoelectric crystals, but also of the quartz crystal resonators found in equipment like electronic watches, computers, TVs, and some radios. FBARs are readily available off the shelf. These energizing and energizable elements are placed in close proximity in two compact groups, resembling a dumbbell, and a number of these dumbbells are strung out in a line and comprise the GW generator. As discussed in Robert M. L. Baker, Jr., Eric W. Davis, and R. Clive Woods (2005), “Gravitational Wave (GW) Radiation Pattern at the Focus of a High-Frequency GW (HFGW) Generator and Aerospace Applications,” in the proceedings of Space Technology and Applications International Forum (STAIF-2005), edited by M. S. El-Genk, American Institute of Physics Conference Proceedings, Melville, N.Y., Volume 746, pp. 1315-1322), the GWs have a focus at the middle of each dumbbell pair and the GW radiation pattern there exhibits a FIG. 8 pattern whose axis is normal to the axis of the dumbbell pairs and also normal to the direction of the jerks associated with each group of energizing and energizable elements at the ends of each dumbbell (please see Baker, Davis, and Woods (2005), ibid, and Landau and Lifshitz, (1975), op cit. pp. 355 to 357). As GWs propagate in both directions along the GW-generator's axis (along the string of dumbbells), those moving in a preferred direction (say to the right) are strengthened by the computer logic system energizing each dumbbell pair in sequence just as the GW crest passes by thereby generating a coherent GW in that direction or a GW beam. In the opposite direction there is no accumulation of GWs and the GWs are incoherent and much weaker. Thus there exists directivity to the GW generator and it is able to channel GWs in a preferred direction. These capabilities qualify such gravitational wave generators for propulsion applications.

### SUMMARY OF THE INVENTION

The present invention provides the generation of gravitational waves (GWs) caused by the interaction of energizing and energizable elements and their application to propulsion. The interaction involves electromagnetic forces or nuclear forces. The important feature of the interaction is that the inertial mass of the energizable elements, taken as a whole, is caused to jerk or harmonically oscillate and thereby generate GW, whereas the energizable masses remain overall stationary. A presently preferred embodiment of the present invention utilizes microwave emissions from commonly available magnetrons, similar to those found in microwave ovens, to energize piezoelectric crystal included in ubiquitous FBARs similar to the ones found in cell phones. In the preferred embodiment, thousands of magnetrons (the energizing elements) are accurately positioned in two groups or clusters some six hundred meters apart (radius of gyration of the ensemble, r=300 m) in a dumbbell configuration. Millions of FBARs (the energizable elements) are accurately positioned and aligned adjacent to thousands of magnetrons housed in a vehicle to be propelled. In each group the FBARs are aligned such that the line of action of their jerks is opposite (180°) to that of the other group at the other end of the dumbbell and acts in the same plane. A computer control logic system adjust the phase of each of the magnetron energizing elements such that the FBARs associated with them are energized in sequence such that they are energized as the GW wave passes them at the speed of light in the direction of the opposite group of FBARs, that is, toward the midpoint or GW focus. The overall dumbbell-shaped ensemble of the two groups of FBARs then emulates the change in the centrifugal-force vector or jerk created by two orbiting masses such as neutron stars or black holes, whose orbital frequency is the same as the magnetron frequency. This process results in the generation of GWs having a frequency of twice the magnetron frequency at the GW focus midway between the two FBAR groups. The GW radiation pattern at the focus is, according to Landau and Lifshitz (1975), op cit., pp. 355 to 357, in the shape of a FIG. 8 whose symmetrical axis is normal to the plane containing the FBAR jerks. In the preferred embodiment a series of hundreds of these dumbbell-shaped sub-assemblies, all in the same plane, is fabricated to be strung out along the axes of the FIG. 8 radiation patterns within a vehicle or a gravitational-wave generation assembly. The computer control logic system controls the overall magnetron phase in each of the dumbbell subassemblies in the series such that as the crest of the GWs in the lobe of the radiation pattern (that extends in the preferred direction) passes, it is reinforced. Thus, the forward-moving GW builds up amplitude as the GW proceeds down the axis of the dumbbell subassemblies and is coherent having the same phase. The GWs also propagate in the opposite direction along the other FIG. 8 lobe. In this case they are not coherent, do not build up and are much weaker than the GWs moving in the preferred direction. Such a gravitational wave generator assembly can be mounted on a vehicle with the direction of the intense coherent gravitational waves or GW beam generated opposed to the desired direction of travel of the vehicle thereby urging the vehicle in the preferred direction of travel by the vehicle's reaction to the momentum being carried away by the gravitational wave. Alternatively, the generated and directed gravitational wave or beam from the GW-generation assembly can change gravity itself along its path and cause a vehicle to be urged in a desired direction.

### BRIEF DESCRIPTION OF THE DRAWINGS

FIG. 1A is a diagram of two masses 1, 2, in a dumbbell-shaped configuration that rotate about a common center 3, on a circular path 4, contained in a plane 5. Centrifugal force vectors 6, 7 from masses 1, 2 result from their motion. As the two masses rotate there are changes in the centrifugal force vectors 8, 9 over time, conventionally referred to as jerks, which generate gravitational waves or GWs. These GWs have a focus at the center 3 and exhibit a radiation pattern 10, the upper lobe of which is directed in the preferred direction 11. According to the radiation pattern, most of the GWs propagate along this preferred direction 11 and in a direction 12 exactly opposite to it, that is, GWs mainly propagate in both directions normal to the plane 5.

FIG. 1B is a diagram of an emulation of the GW generation in FIG. 1A in which the two masses or dumbbell-shaped devices are replaced by two groups or clusters of energizing and energizable elements, typically 13, 14, also of a dumbbell shape. These two groups are composed of energizing elements, such as magnetrons, e.g., similar to those found in microwave ovens, typically 15, and a plurality of energizable elements, such as piezoelectric crystals e.g., FBARs similar to those found in cell phones, typically 16. Each of these energizable elements 16 when energized produces a small change in force 17. There is a resultant or sum of these small force changes that act, when the small force changes 17 are coplanar, in equal and opposite directions 18, 19 tangential to an imaginary circle 20 that is also in the plane 21 (emulating the path 4 and plane 5 of FIG. 1A). The resulting force changes 18, 19 over the period of the emanations, e.g., microwaves, are jerks and generate GWs. As in FIG. 1A the GWs exhibit a FIG. 8 radiation pattern 22 around the generator's focus 23.

FIG. 2 is a diagram of a collection or array of these dumbbell-shaped subassemblies 24 strung out along a line or axis 25. Each one of these subassemblies exhibit a GW radiation pattern at its center typically 26 whose axes typically 27 are coincident with the line or axis 25. All of the dumbbell-shaped subassemblies are contained in the same plane 28 that is the same as plane 21 of FIG. 1B. When all of the elements of the subassemblies are synchronized they are energized as the crest or front of a GW passes by each subassembly's midpoint or GW focus so that the entire assembly generates large coherent GWs in direction 29 and much smaller intensity incoherent GWs in the opposite direction 30. This process results in a reinforced, higher-intensity, coherent GW or GW beam having a directivity 29.

FIG. 3 is a schematic of a propulsion system utilizing a plurality of gravitational-wave-generator subassemblies 31, the same as the dumbbell-shaped subassemblies 24 diagrammed in FIG. 2, disposed within a vehicle housing 32. The GWs are primarily channeled in the rearward direction 33, which act in a direction opposed to the preferred direction of travel 34. The rearward moving GWs 33 exit the rear of the vehicle 35 propelling the vehicle in the desired direction of travel 34. The energizing elements are powered by a power supply 36 and a computer controlled logic system 37 housed in a chamber 38. Conductors 39 transmit power from the power supply via the computer controlled logic system to the energizing elements.

FIG. 4 is a schematic of a propulsion system utilizing the change in gravity occasioned by the passage of High-Frequency Gravitational Waves (HFGWs) as described in Landau and Lifshitz (1974) op cit. p. 349, and in '597. A plurality of gravitational-wave-generator subassemblies 40 are located interiorly or exteriorly to an object 41, which can be a spacecraft, missile, or land-going vehicle. A focusing device such as a superconducting refraction lens 42 described in '591 could, as an alternative embodiment, concentrate the HFGW in a specified region of space 43 so as to modify the gravitational field there and urge the object 41 in a desired direction 44. Without the focusing device the HFGW 45 could also be directed by the inherent directivity of a plurality of gravitational wave generator subassemblies, acting synchronically and in concert, to a specific region of space 43 so as to modify the gravitational field there and urge the object 41 in a desired direction 44.

FIG. 5 is a schematic of the cross-section of a Film Bulk Acoustic Resonator or FBAR. The vibrating membrane 46 and the metallization 47 has an Aluminum Nitride (AlN) piezoelectric 48 layered between its leaves and is mounted on a Si₃N₄ sheet 49, which is in turn mounted on silicon wafer material 50.

FIG. 6 is a simplified model of the FBAR acoustic resonator. It is composed of a spring 51, having a spring constant k, acted upon by a force f=kx 52 where x is in the direction shown and the FBAR piezoelectric element has a mass m 53.

The gravitational wave generators are under the control of a computer controlled logic system involving an orbit or trajectory determination algorithm (described in R. M. L. Baker, Jr. “Astrodynamics, Applications and Advanced Topics,” Academic Press, New York, 1967) in order to define the desired direction of travel 42 for the propulsion system.

### DETAILED DESCRIPTION OF THE INVENTION

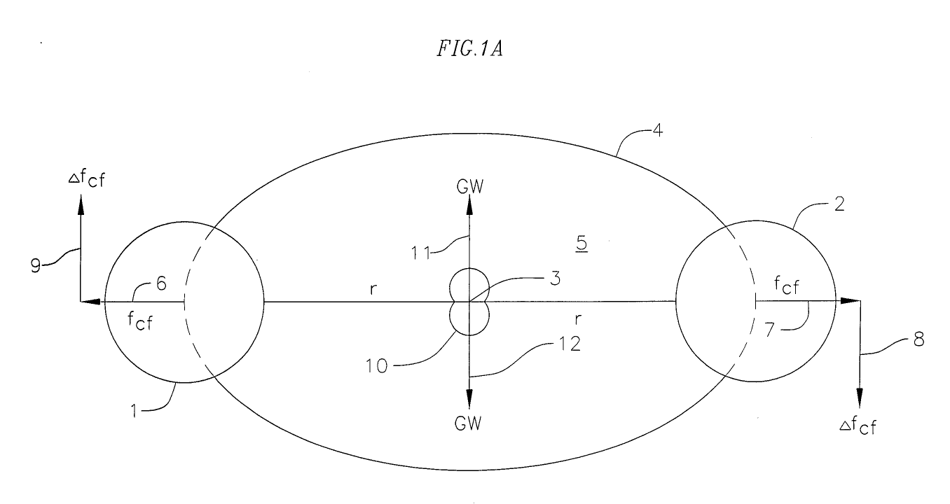

In FIG. 1A, the preferred embodiment is illustrated by the GW generation by a double-star 1, 2 on orbit 4. Due to the change in the centrifugal-force vectors 8, 9 with time (termed jerks) as the star masses progress around their orbit, GWs 11, 12 are generated and emanate from a focus 3. The GW radiation pattern there is like FIG. 8 according to Landau and Lifshitz (1975) op cit., pp. 355 to 357. Its quantitative value is given by Eq. (10) of Baker, Davis, and Woods (2005) op cit. In FIG. 1B this orbital-mass generation process is emulated by the jerks associated with piezoelectric crystal energizable elements 16 as energized by magnetrons 15. The magnetron-crystal sets are distributed in a compact volume 13. For simplicity of illustration that volume of these sets is shown to be spherical, but the volume containing these energizing and energizable elements could be of almost any form. The concept is to energize these distributed elements in a sequence so as to replicate the distributed molecules under gravitational force in the stellar masses of FIG. 1A 1, 2. Such a sequence is achieved by controlling the magnetron energizers to emit in sequence as the microwave crests pass each cluster of piezoelectric crystals to be energized by them as the microwaves move toward the center 23. A simple timing or phase determining program is executed by the computer control logic system to implement the concept. The energizable elements can also be permanent magnets, electromagnets, solenoids (or nano-solenoids) current-carrying plates, piezoelectric crystals, nano-machines including harmonic oscillators, nano-motors and nano-solenoids or micro-electromechanical systems (MEMS) in general, rings of energizable elements, nano- or x-ray-laser targets, superconductor vortexes and mini- or nano-cyclotrons or nano-synchrotrons as discussed by P. M. Murad and R. M. L. Baker, Jr. in “Angular Momentum and Other Anomalies in a Gravitational Wave Field.” Gravitational-Wave Conference, edited by P. Murad and R. Baker, The MITRE Corporation, McLean, Va., May 6-9, 2003, Paper HFGW-03-114, pp. 11-12, which is incorporated herein by reference. In the case of solenoids (or nano-solenoids), some nano-machines, nano-electromechanical systems, current-carrying plates, etc. the energizing and energizable elements can be placed in the same location, for example, by placing the energizing coil around the energizable central magnetic core in the case of the nano-solenoids or nano-lasers energizing mechanisms and micro-target energizable elements. The energizing elements in the context of the '597 patent would include coils, current pulses moving in conductors, bio-molecular motors, laser beams, etc. that operate under the control of an Individual Independently Programmable Coil System (IIPCS), described in the parent Patent '336.

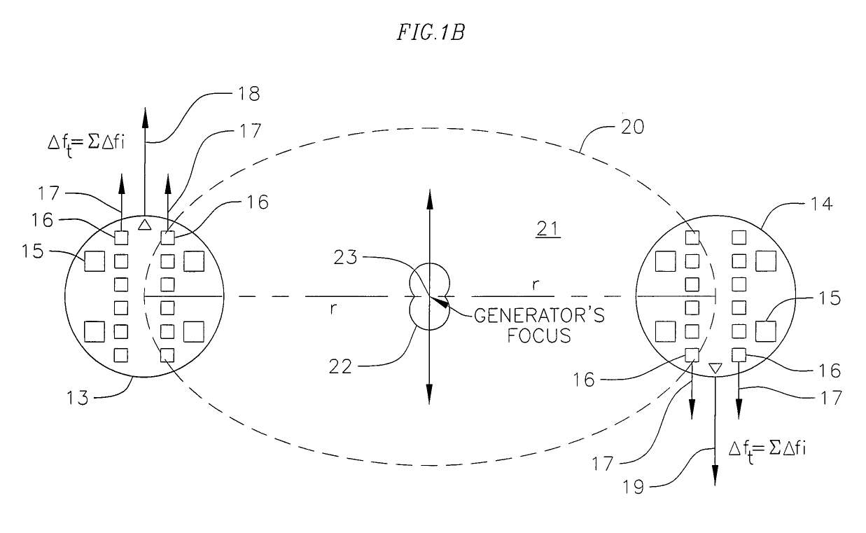

In FIG. 2 these dumbbell-like subassemblies 24 are strung out in row 27 with their radiation patterns 26 aligned along the same axis 29, 30 and all subassemblies contained in the same plane 28. For simplicity of illustration these subassemblies are shown as individual devices. They could be merged into parallel rows of energizing and energizable elements and not of individual spherical form and for that matter they could be in a volume of any shape that has the energizable elements symmetrically distributed about the central axis. The distribution of the energizable elements must, however, be circumferentially asymmetrical. Specifically, dumbbell-like distributions can emit GWs whereas ring-like distributions do not. For example, rotating rods emit GWs, but revolving rings and spinning balls do not. The concept is to generate GWs at the midpoint radiation patterns 26 such that as the crest of the generated GWs proceeds down the axis from 30 to 29 they are reinforced and are coherent and form a GW beam. The GWs moving in the opposite direction from 29 to 30 will not be reinforced, be less intense, and incoherent. In general the GW wave front is reinforced or constructively interfered with by energizing the energizable elements from 30 to 29 and/or possibly by destructive interference of one GW with another (as in the astrophysical case of a uniformly, isotropically exploding or collapsing star) from 29 to 30.

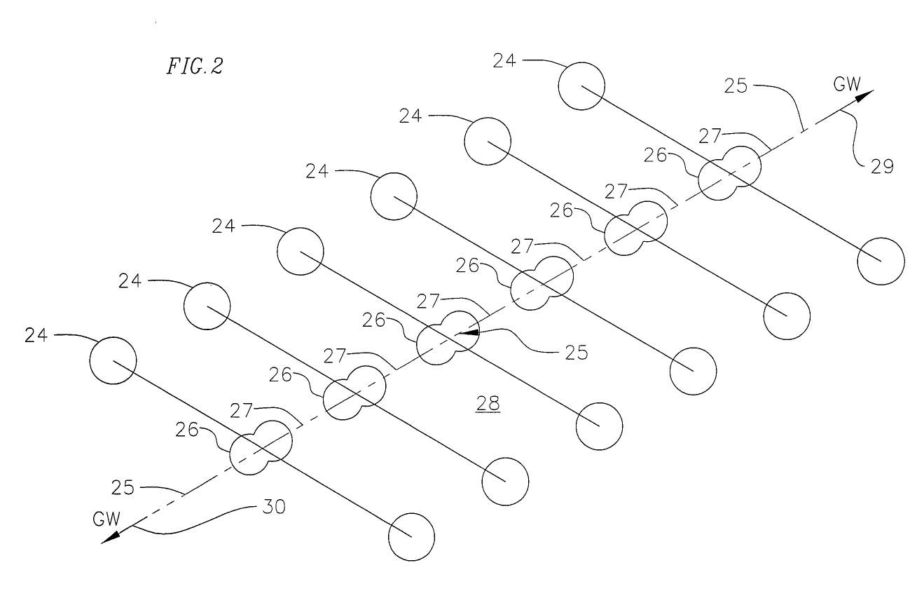

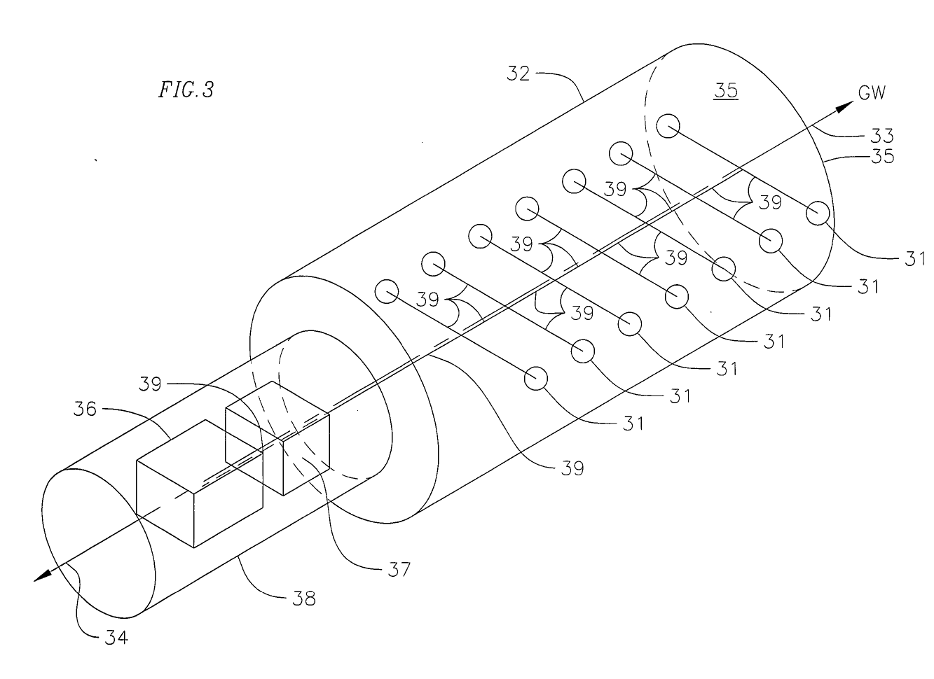

In FIG. 3 the gravitational wave generator assembly of FIG. 2 is disposed within a vehicle housing 32. There is a power supply 36 that could be nuclear, photovoltaic, a fuel cell, or any other source. The power from it leads to the various magnetron energizing elements via conductors 39 through the computer control logic system 36. This system not only provides the sequencing or phase-control signals to the magnetrons, but also controls the GW amplitude and polarization in concert with a navigation or maneuvering computer program. For operations in space such a system is described in Baker (1967) op cit. The vehicle illustrated in FIG. 3 can also be interpreted as the housing of a directed gravitational-wave or GW-beam generation device with its self-contained power supply 36 and computer 37 as shown in FIG. 4 40. The 4.9 GHz GWs generated by such magnetron energized devices are considered to be High-Frequency Gravitational Waves or HFGWs as defined in Hawking, S. W. & Israel, W. General Relativity: An Einstein Centenary Survey (Cambridge University Press, Cambridge, 98, 1979). As Landau and Lifshitz (1975) op cit. p. 349 indicates “Since it has a definite energy, the gravitational wave is itself the source of some additional gravitational field. Like the energy producing it, this field is a second-order effect in hᵢₖ. But in the case of high-frequency gravitational waves the effect is significantly strengthened: the fact that the pseudotensor t^{ik} is quadratic in the derivatives of hᵢₖ introduces the large factor λ_{GW}⁻². In such a case we may say that that the wave itself produces the background field on which it propagates. This field is conveniently treated by carrying out the averaging described above over regions of four space with dimensions large compared to λ_{GW} (which in the case of magnetrons and FBARs is about 6 cm). Such an averaging smoothes out the short-wave “ripple” and leaves the slowly varying background metric (or gravitational-field change).”

In FIG. 4 is shown a gravitational-wave or GW-beam generation device that exhibits directivity 40. Also shown is the alternative embodiment involving the utilization of a medium in which the gravitational wave speed is reduced in order to effect refraction of the gravitational wave, in this embodiment a gravitational wave lens 42, as discussed in '597, to focus and intensify the emitted GWs 45 on a specific volume of space 43. As shown by Landau and Lifshitz (1975), ibid, GWs can be directed in order to propel an object 41 by changing the gravitational field nearby an object 43 to urge it in a preferred direction 44 and be propulsion means.

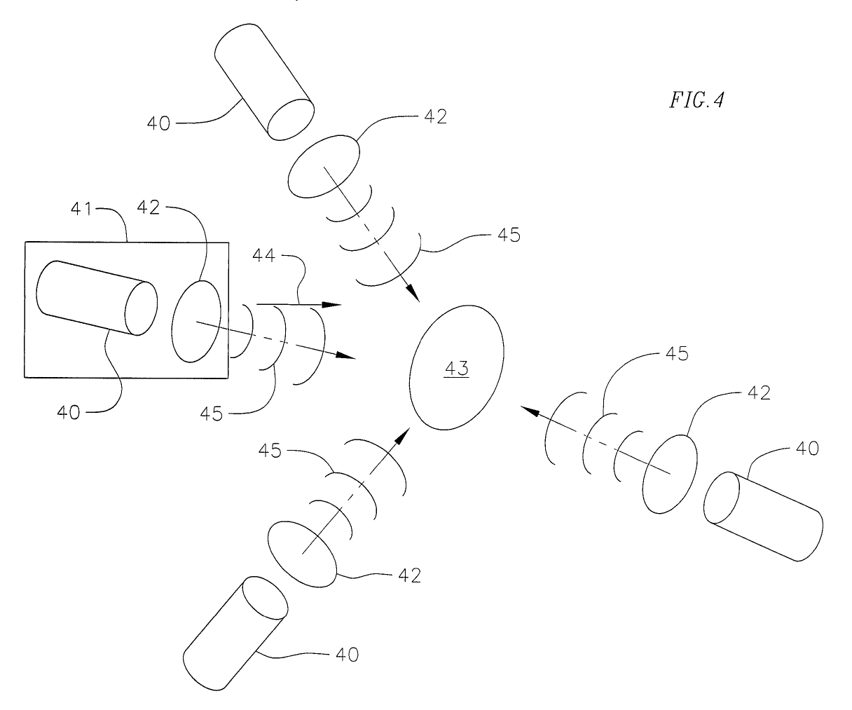

In FIG. 5, is shown a schematic cross section of the energizable Film Bulk Acoustic Resonator or FBAR of the preferred embodiment. An FBAR is a mechanical (acoustic) resonator consisting of a vibrating membrane 46 (typically around 100×100 μm² in plan form, and around 1 μm thickness), fabricated using well-established integrated circuit (IC) micro-fabrication technology. The vibrating membrane 46 is actuated piezoelectrically, typically using aluminum nitride (AlN) as the piezoelectric excitation material 47. These devices have recently been highly developed as cost-effective radio frequency or RF filters mainly for use in commercial cellular telephones, in which high-Q resonators are needed for the typical carrier frequency band around 1.9 GHz. Exploratory FBAR devices have been fabricated operating at frequencies up to 7.5 GHz (Ruby, R., Bradley, P., Larson, J. D., and Oshmyansky, Y., “PCS 1900 MHz Duplexer Using Thin Film Bulk Acoustic Resonators (FBARs),” Elec. Lett., Volume 35, 794-795 (1999) and Lakin, K. M., Belsick, J., McDonald, J. F. and McCarron, K. T., “High Performance Stacked Crystal Filters for GPS and Wide Bandwidth Applications,” in IEEE Ultrasonics Symposium, IEEE, Piscataway, N.Y., 2001, 833-838.). The vibrating membrane 46 in an FBAR will also form an ideal vibrating mass for the present application, at slightly higher frequency.

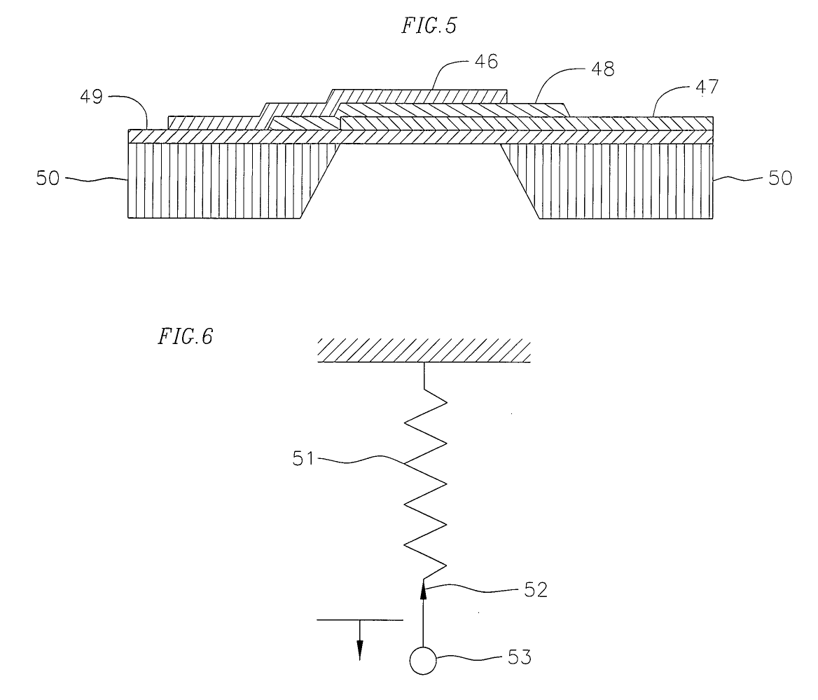

In FIG. 6, is shown a simple model of an FBAR acoustic resonator. The resonance quality factor is given by the well-known result Q=ωₒ×(stored energy)/(power applied), where ωₒ is the resonant angular frequency, and so the stored energy is:
W=Q×(power applied)/ωₒ. (1)
The vibrational mode of an FBAR membrane is actually a low-order Lamb wave (Auld B. A., Acoustic Fields and Waves in Solids, Vol. II 2nd. Ed., Krieger, Malabar, Fla., 1990, p. 85.) A simple approximation will be accurate enough for a first estimate of the FBAR jerks, that is, of the amplitude of the time-varying force within a FBAR. The mass m 53 fixed to the end of a spring 51 having a spring (force) constant k oscillates at a natural angular frequency ωₒ=(k/m)^{1/2}=2πνₒ so that:
k=ωₒ² m. (2)
the energy stored in the oscillation is given by W=½ kx²=½(kxₒ)²/k=½ fₒ²/k for an oscillation amplitude xₒ and maximum force fₒ. From Eq. (2) the maximum force applied to the mass is:
fₒ=(2 W k)^{1/2}=(2 Wωₒ² m) (3)
Suppose the total excitation power available is Pᵢₙ divided equally between N FBARs. Then the power supplied to each FBAR is Pᵢₙ/N (assuming, of course, no loss from power distribution or phase adjusting), so that from Eq. (1) the stored energy per FBAR is W=QPᵢₙ/(Nωₒ). Combining this with Eq. (3) gives the force in each FBAR:
fₒ=(2Q Pᵢₙ ωₒ m/N)^{1/2}. (4)
Therefore, the total force experienced by N FBARs excited in phase is (2QPᵢₙωₒ(mN)^{1/2}. Note that the total force is proportional to N^{1/2} rather than to N, because with more FBARs, but fixed total input power Pᵢₙ, then the power per FBAR is reduced. To maximize the total force and, therefore, the jerk, the largest possible number of FBARs is needed, operating at the highest possible frequency and largest possible input power. A typical FBAR has a resonance curve with a pass band resonance width of 2Δν=24 MHz at a typical pass band center frequency νₒ=2 GHz (Lakin et al., (2001) op cit.). This gives Q≈2000/24≈100. Mass m is found from density×volume. The values density=3000 kg m⁻³ (typical of materials comprising an FBAR membrane) and volume=100×100×1 μm³ (typical of an FBAR membrane resonant at νₒ=2 GHz) were estimated here, so that m=30 ng. A typical FBAR takes up rather more area than its nominal membrane area 100×100 μm² in a fabricated silicon wafer. Current silicon fabrication foundries can process 4″ diameter (or larger), 6000 (or more) FBARs may easily be fabricated on one wafer (Lakin et al., 2001, ibid) if there are significantly silicon wafers as standard. From these figures it is straightforward to calculate that, at a very conservative estimate more than 6000 FBARs on each wafer, the total force is proportional to 10 and so the generated HFGW flux according to the quadrupole equation, '597, is proportional to (N^{1/2})²=N. One can also look at this as simply the addition of all of the GW power lobes 26 in FIG. 2 to generate the final emitted GW power 29. FBARs are quite simple to fabricate using standard microelectronics procedures. In order to clarify the enabling of the present invention, a cost analysis using 2005 U.S. dollars is useful. A very rough estimate of the FBAR wafer cost is US$10 per wafer (in bulk quantities). (In fact it would be economically advantageous to use 6″ or 8″ diameter wafers but here 4″ wafers are assumed.) Suitable magnetrons giving 1 kW at 2.45 GHz are readily available in bulk off-the-shelf at about US$30 each, intended for OEM microwave oven use. To find the best distribution of magnetrons and FBAR wafers, note that the HFGW flux is proportional to the product (PᵢₙN); this product must be maximized subject to the constraint of minimum cost. This is an optimization problem and the solution is: equal sums should be spent on the magnetrons and on the FBAR wafers.

### NUMERICAL EXAMPLE

As an illustrative example, the optimum arrangement is to have each 1 kW magnetron drive three 4″ FBAR wafers, assuming the rough estimates of costs given above. This excitation corresponds to ˜56 mW per FBAR, well within the power-handling capacity of this type of device (typically ˜2 W per FBAR is reported by Ruby, R., Bradley, P., Larson, J. D., and Oshmyansky, Y., “PCS 1900 MHz Duplexer Using Thin Film Bulk Acoustic Resonators (FBARs),” Elec. Lett., Volume 35, 794-795 (1999). Suppose that US$6M, an arbitrarily chosen sum, is available for the total hardware cost of the magnetrons and FBAR wafers. The optimum design at this price consists of 100,000 magnetrons, costing US$3M, driving a total of 300,000 FBAR wafers (total of 1.8×10⁹ FBARS), also costing US$3M The magnetrons are situated in clusters 600 m apart so that the radius of gyration, r, is 300 m, Laser surveying devices would be necessary to align all the energizable FBAR elements accurately towards the central focus to about one cm. From Eq. (4), using Q=100, Pᵢₙ=100 MW, and ωₒ=2π×2.45 GHz, the total force each cycle is Δf˜10⁹N. The magnetron frequency, 2.45 GHz, corresponds to a generated HFGW frequency VGW=4.9 GHz. The number of gravitons generated per second, n, is
n=power/graviton−energy=1.76×10⁻⁵²(2rΔfν_{GW})²/hν_{GW}˜1.5×10²⁴s⁻¹ (5)
in this example.

As a possible application of one embodiment of the gravitational wave generation concept of the invention, one could install the opposing magnetron-FBAR groups or clusters, the energizing and energizable elements, on two satellites on coplanar geosynchronous orbits located on opposite sides of the Earth at a distance apart of ˜8×10⁷ m or the radius of gyration, r˜4×10⁷ m. Careful alignment of the energizable elements by means of servomechanisms could allow for the positioning of the HFGW focus at any location between the two clusters in the environs of the Earth. The satellite power supply would be less than 100 MW and we will reduce it to 100 kW. Due to the square root relationship of the change in force with energizing element power, that is with the number N of energizable elements excited in phase, Δf˜4×10⁸ N. From the jerk, or third time derivative of motion, formulation of the quadrupole equation '597, with ν_{GW}=4.9 GHz, we compute P 4.2 W. At the diffraction-limited 2.3×10⁻³ m² area focal spot, the HFGW flux would be F_{GW}=˜2×10³ Wm⁻² continuous. If the groups or clusters of energizing elements, e.g., magnetrons, and energizable elements, e.g., FBARs, were at lunar distance (e.g., at the Moon and the L₃ lunar libration point, Baker (1967), op cit., pp. 126, 132, 133), then the HFGW power there would be about 420 W and the flux focused at any point in the environs of the Earth would be about 2×10⁵ Wm⁻² or about one hundred times greater than the solar radiation flux at the Earth.

What is claimed is:

1. A gravitational wave propulsion system comprising:
a gravitational wave generator for producing gravitational waves along a predetermined axis of generation; and
a housing for the gravitational wave generator aligned along the axis of generation for channeling and directing the gravitational waves in a direction opposed to a preferred direction of travel.

2. A gravitational wave propulsion system according to claim 1 wherein the housing includes a refractive control medium for focusing and altering the direction of the gravitational waves.

3. A gravitational wave propulsion system according to claim 2 in which the refractive control medium is a superconductor.

4. A gravitational wave propulsion system comprising:
a gravitational wave generator for producing gravitational waves along a predetermined axis of generation that are a source of a gravitational field and
a housing for the gravitational wave generator aligned along the axis of generation for channeling and directing the gravitational waves in a direction that will create a change in the gravitational field to urge an object in a preferred direction of travel.

5. A gravitational wave propulsion system according to claim 4 wherein a refractive control element is located within the housing for altering the direction of travel of the gravitational waves.

6. A gravitational wave propulsion system according to claim 4 wherein a plurality of gravitational wave generators, which change the gravitational field in the vicinity of an object and urge the object in a preferred direction, are positioned in operative relation to and located exteriorly of the object.

7. A gravitational wave propulsion system according to claim 4 wherein a plurality of gravitational wave generators, which change the gravitational field in the vicinity of an object and urge the object in a preferred direction, are positioned in operative relation to and located interiorly of the object.

8. A gravitational wave propulsion system according to claim 4 wherein a plurality of gravitational wave generators, which change the gravitational field in the vicinity of an object and urge the object in a preferred direction, are positioned in operative relation to and located exteriorly of the object so as to create at least one gravitational field of a predetermined intensity at a predetermined location to urge the object in a preferred direction.

9. A gravitational wave propulsion system according to claim 4 in which the object is a vehicle.

10. A gravitational wave propulsion system according to claim 9 in which the vehicle is a spacecraft.

11. A gravitational wave propulsion system according to claim 9 in which the vehicle is a missile.

12. A gravitational wave propulsion system according to claim 9 in which the vehicle is a mobile conveyance operating on land.

13. A gravitational wave propulsion system according to claim 4 in which the refractive control element is a vehicle trajectory processor.

14. A gravitational wave propulsion system according to claim 13 in which the refractive control element is a superconductor.

15. A gravitational wave generating system comprising:
a gravitational wave generator for producing gravitational waves that consists of two clusters of one or more sets of energizing and energizable elements that emulate the third time derivative of the motion of a pair of masses rotating about one another,
means for aligning the third time derivative motion of the energizable elements so as to focus the gravitational waves generated by them at a preferred location between the two clusters, and
a computer controlled logic system for controlling the alignment means.

16. A gravitational wave generating system according to claim 15 in which the clusters are located in a terrestrial location.

17. A gravitational wave generating system according to claim 15 in which the clusters are located in outer space.

18. A gravitational wave generating system according to claim 17 in which the clusters that are located in outer space are at the Moon and the L₃ lunar libration point.
